(19) United States
(12) Patent Application Publication
(10) Pub. No.: US 2010/0198657 A1
(43) Pub. Date: Aug. 5, 2010

(54) SYSTEM AND METHOD FOR PLANNING THE ESTABLISHMENT OF A MANUNFACTURING BUSINESS

(76) Inventor: Rajenda Singh, Clemson, SC (US)

Correspondence Address: MCNAIR LAW FIRM, P.A., P.O. BOX 447, GREENVILLE, SC, 29602-0447, US

(21) Appl. No.: 12/711,831

(22) Filed: Feb. 24, 2010

Related U.S. Application Data
(63) Continuation-in-part of application No. 11/008,465, filed on Dec. 9, 2004.

(51) Int. Cl. G06Q 10/00; G06Q 50/00

(52) U.S. Cl. 705/10; 705/348

(57) ABSTRACT

A method for planning the establishment of a business comprising the steps of providing partner characteristic information representing objective representations of characteristics of potential suppliers of goods and/or services, providing location characteristic information representing objective representations of characteristics of potential business locations, providing a minimum profit desired for the operation of said business, determining constraints for optimizing potential partners and potential locations to be used for determining profits according to a selected partner and selected locations; and determining a set of results wherein each member of said set of results contains at least one potential partner and at least one potential location according to said constraints.

### CROSS REFERENCE TO RELATED APPLICATION

This application is a continuation-in-part of application Ser. No. 11/008,465, filed Dec. 9, 2004 having the same title.

### FIELD OF THE INVENTION

This invention relates to a system for planning the establishment a multi-product manufacturing business. Specifically, this invention relates to the feasibility and practicality for establishing manufacturing businesses in locations where resources such as infrastructure, technology, or capital may be in limited supply.

### BACKGROUND OF THE INVENTION

Manufacturing companies desire to place manufacturing facilities in locations that are able to take advantage of particular resources such as the availability of low wage workers or transportation infrastructure in hopes of leveraging these resources to ultimately maximize profits. However, once a business is operating for some time in a specific location, the wages of the location increase and businesses re-evaluate the location of their operations in hopes of finding more advantageous resources such as low-wages. However, these other locations may lack infrastructure or research and development resources desired by the business. If these resources are needed, the business may need to expend a significant amount of capital to create business. Therefore, a system for analyzing the establishment of a business of a particular location is a problem that significant attention needs to be placed. Additionally, there is a need for a system that can assist with the relocation or creation of a business that considers cost-competency and quality (CCQ).

Further, there are typical disadvantages with some locations that, while having a low cost work force, may not have the distribution infrastructure, utility infrastructure, sufficiently educated work force or other resources desirable to the business.

For example, if a business wishes to locate a semi-conductor foundry to a particular location, it would be desirable to have a knowledgeable work force so as to have a work force that does not require excessive training. The need to train such a work force may require capital that results in less funding available for other costs. Since the start-up costs of a foundry can be quite high, the minimization of capital spent on training a work force is desirous.

Further, development of other desired resources in a particular location requires capital As such, minimizing the capital required for development of resources in a particular location is desirous.

Therefore, a system providing analysis of the development and operation of a high tech business such as a semiconductor foundry in specific locations is a problem that needs considerable attention. Further, the ability to analyze the feasibility and costs of a business placed in a particular location would be advantageous. Particularly, a system for analyzing the feasibility and cost of locating a high tech business in a disadvantaged location would be advantageous. For example, a system able to determine if the savings associated with a low cost work force would outweigh costs associated with developing other resources would be advantageous.

Further, the selection of business partners can be important to the operation of any business. For example, a business may need partners to provide goods such as raw materials, technology, capital, utilities and facilities. A business may also utilize partners to provide services such as legal, accounting, janitorial, security and other services. A system that can consider the financial and feasibility consequences of selecting a partner would be advantageous.

Further, the capital and resources spent on research and development can result in technology, products, and know-how that can give a business a considerable market advantage. Protection of these efforts is a consideration that can be very important to a business. When selecting a location, the intellectual property protection allowed under the laws of the desired location can influence whether a business decides to locate in that location. Therefore, a system that considers the intellectual property protection of a potential location for determining the cost and feasibility of selecting that location would be advantageous.

### SUMMARY OF THE INVENTION

The invention provides a method for planning the establishment of a business comprising the steps of providing partner characteristic information representing objective representations of characteristics of potential partners, providing location characteristic information representing objective representations of characteristics of potential business locations, providing a minimum profit desired for the operation of said business, determining constraints for optimizing potential partners and potential locations to be used for determining profits according to a selected partner and selected locations, and determining a set of results wherein each member of said set of results contains at least one potential partner and at least one potential location according to said constraints. The step of ranking each member of said set of results by its associated profit may also be included.

The step of providing a business type representing objective representations of characteristics of said business type, and said step of determining constraints includes the step of determining constraint according to business type may also be included. The step of determining constraints includes the step of determining linear constraints for global optimization algorithms. The step of determining said set of results includes the step of determining said set of results according to global optimization algorithms may also be included. The steps of selecting at least one location from said set of results for locating said business and raising capital to finance the establishment of said business at said selected location may also be included. The steps of selecting at least one location from said set of results for locating said business and determining what legal issues are to be resolved prior to locating said business at said selected location may also be included. The step of determining the effect on profit according to costs associated with resolution of what legal issues are to be resolved prior to locating said business at said selected location may also be included.

At least one member of said set of results contains a plurality of potential partners, selecting a plurality of partners from said member containing a plurality of potential partners, and determining whether a conflict exists between said plurality of selected partners. The step of removing at least one partner from said selected plurality of partners if a conflict is discovered according to said discovered conflict may also be included.

A system for planning the establishment of a business comprising at least one processor, a computer readable medium in communications with said at least one processor, a set of partner information in communications with said computer readable medium representing objective representations of characteristics of potential partners, a set of location information in communications with said computer readable medium representing objective representations of characteristics of potential business locations, a set of computer readable instructions that, when executed by said at least one processor, receive a minimum profit desired for the operation of said business, receive constraints for determining potential partners, receive constraints for determining potential locations, determine profits according to a selected partner and selected locations, and determine a set of results wherein each member of said set of results contains at least one potential partner and at least one potential location according to said constraints.

The computer readable instructions may include instructions for ranking each member of said set of results by its associated profit. The computer readable instructions may include receiving a business type representing objective representations of characteristics of said business type and said instructions for determining said set of results includes the determination according to business type. Business type includes at least one of nanosystems manufacturing and microsystems manufacturing. The set of instructions include instructions for determining constraints includes a determination of linear constraints for global optimization algorithms. The set of computer readable instructions includes instructions for determining said set of results according to global optimization algorithms. The set of computer readable instructions includes instructions for selecting at least one location from said set of results for locating said business and raising capital to finance the establishment of said business at said selected location. The set of computer readable instructions includes instructions for selecting at least one location from said set of results for locating said business and determining what legal issues are to be resolved prior to locating said business at said selected location. The set of computer readable instructions include instructions for determining the effect on profit according to costs associated with resolution of legal issues prior to locating said business at said selected location.

One member of said set of results contains a plurality of potential partners and, said set of computer readable instructions include instructions for selecting a plurality of partners from said member containing a plurality of potential partners and determining whether a conflict exists between said plurality of selected partners. The computer readable instructions include removing at least one partner from said selected plurality of partners if a conflict is discovered according to said discovered conflict.

### DESCRIPTION OF THE DRAWINGS

The construction designed to carry out the invention will hereinafter be described, together with other features thereof.

The invention will be more readily understood from a reading of the following specification and by reference to the accompanying drawings forming a part thereof, wherein an example of the invention is shown and wherein:

FIG. 1 is a schematic diagram illustrating an embodiment of a system according to the invention;

FIG. 2 is a flowchart showing the operation of the invention;

FIG. 3 is a flowchart further showing the operation of the system;

FIG. 4 is a flowchart further showing the operation of the system;

FIG. 5 is a flowchart further showing the operation of the system;

### DETAILED DESCRIPTION OF THE INVENTION

The detailed description that follows may be presented in terms of steps of methods or in program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or optical signals including, data, audio, and voice signals capable of being stored, transferred, combined, compared, or otherwise manipulated. A computer readable medium can be included that is designed to perform a specific task or tasks. Actual computer or executable code or computer readable code may not be contained within one file or one storage medium but may span several computers or storage mediums. The term “host” and “server” may be hardware, software, or combination of hardware and software that provides the functionality described herein.

The present invention is described with reference to flowchart illustrations of methods, apparatus (“systems”), or computer program products according to the invention. It will be understood that each block of a flowchart illustration may be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions.

The present invention is now described more fully herein with reference to the drawings in which the preferred embodiment of the invention is shown. This invention may, however, be embodied in many different forms and should not be construed as limited to the embodiment set forth herein. Rather, these embodiments are provided so that this disclosure will be thorough and complete and will fully convey the scope of the invention to those skilled in the art.

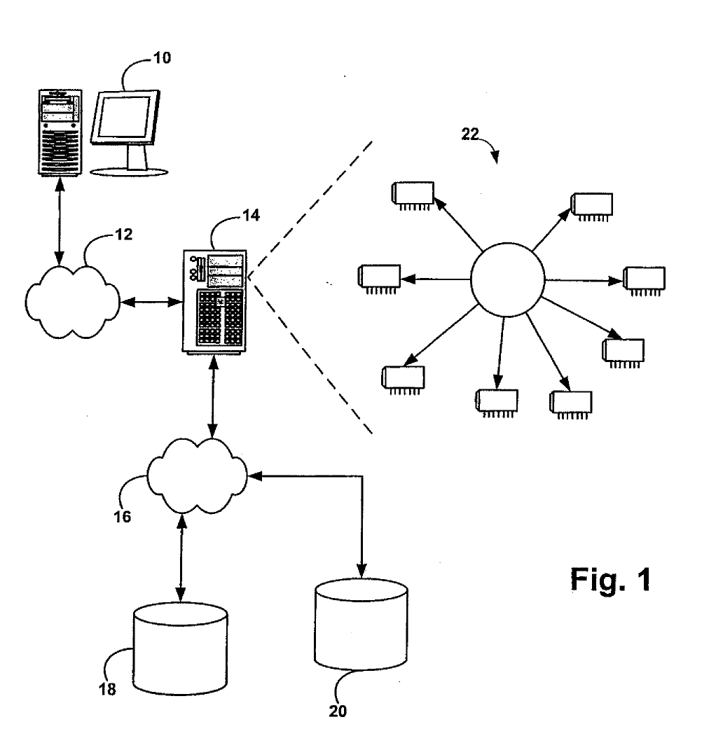

Referring now to FIG. 1, a schematic of the invention is shown. In one embodiment, a user on a remote computer 10 accesses a set of computer readable instructions that allow the user to make decisions for operating a multi-product manufacturing business. The computer readable instructions, also termed a program, may be located on remote computer 10 or on a server 14 and accessible by remote computer 10 through a network 12. Alternatively, a hardware neural network shown as 22 on FIG. 1 can be used to make determinations. As compared to the pure software implementation of this invention, the hardware neural network provides advantages concerning computational performance. Neural networks can be implemented using multiple semi-conductors, each representing a neuron in the network and resulting in a neural network through hardware. Traditionally, however, the number of neurons implemented using semi-conductors has been limited by physical constraints as space and parochial constraints as equipment. By using silicon integrated circuits of approximately 65 nm in feature size, it is possible to place approximately a billion transistors on a single chip. Some advantages of neural network processes are explained more fully in Dominant Role of Single Wafer Manufacturing in Providing Sustained Growth of the Semi-Conductor Industry by R. Singh, et al, as published in the 19^{th} Edition of Semiconductor Fabtech herein incorporated by reference. The number of neurons in the human brain is estimated to be at approximately 100 billion. With an average of 1000 neurons per connections, there are approximately 100 trillion connections in an average human brain. With the availability of low-cost and ultra high speed silicon based nanoelectronics, the human brain can be mimicked by using different computer architecture than is used in conventional computers. The artificial neural network has the capability of partially realizing the capabilities of human brain in a chip. The hardware implementation of artificial neural networks can take advantage of their inherent parallelism and run orders of magnitude faster than software simulations.

Further, the determination of possible locations for the business may be made based on a minimum profit criteria entered by the user of the system. In an alternative embodiment, network 12 is the Worldwide Web. There are two main sets of information in the system for locating and operating a multi-product manufacturing business. Remote terminal 10 may be able to access a partner database 18 having information regarding potential suppliers of goods and services such as suppliers of financial capital, physical capital, materials, labor, service, raw materials, experience, industry knowledge and references. The remote terminal may also have access to a location database 20 having information regarding characteristics of potential locations such as workforce information, workforce costs, location economic development incentives, location regulations, location tax information, information infrastructure, transportation infrastructure, location culture information, location quality of life and higher education information. All members of the location and partner databases may have a business type field that allows the user to sort and retrieve locations based on business types. Manufacturing of different products can be classified according to the industry the product belongs. Various types of industries are described in “Statistical Abstract of the United States, 1995, no. 1286”. A typical example of the industry type is electronics and other electrical equipment. Within electronics and other electrical equipment there are a number of business types. One example of a business type is “semiconductor chip manufacturing.” The other type will be “hard disk drive manufacturing”. Within each business type there will be different business partners. As an example, in case of semiconductor business manufacturing the following business partners may be desired: (1) manufacturers and/or suppliers of all type of equipment used in the semiconductor manufacturing facility called, “fab”, (ii) supplier of all kind of materials, gases, chemicals, and silicon, wafers (iii) supplier of special software used to manage the operation of the “fab” (iv) integrated device manufacturers with the expertise of technology used in the manufacturing of chips, and (v) customers who brings their custom-design that is used for the manufacturing of chips. Business types can include Microsystems, which are integrated functional structures, where transistor feature size is of micrometer-scale dimensions; and Nanosystems, which are integrated functional structures, where feature size of transistor and/or other functional devices (optical, mechanical, biological, chemical, thermal, energy conversion, sensing, detecting) are of the order of 0.1-100 nm dimensions.

For manufacturing future generations of Microsystems and Nanosystems, the present invention reduces significantly the time to market a product from inception to mass scale manufacturing. This is due to the selection of appropriate business partners from the partner database and location from the location database that results in reduction of design time, faster engineering services and achievement of highest yield in minimum time and provides desired profitability. As a result of these attributes, the present invention enables the “turn key operation” of future Microsystems and Nanosystems manufacturing system

The partner database contains partner characteristics that are associated with potential suppliers of goods and/or services. Partner characteristics include information such as the category of the partner. Examples of categories of partners include financial, logistics, administrative, governmental, technical and customer. Within each category of partner, characteristics associated with that category can be included.

For example, partner characteristics associated with the financial partner category can include whether the potential supplier has sufficient money to invest in the new company and the types of businesses in which the financial partner is willing to invest. Further characteristics included in the financial partner category could include a quantified representation of the scope and type of control the financial partner would expect on the business in return for the partner's investment. One financial partner may require 75% ownership in equity while another may only need 20%. One financial partner may need two seats on the Board of Directors while another may not require any seats. Further, the capital available from the potential financial partner can be included in the partner characteristics information. The cost of the capital to the business can also be included in the partner characteristic information. The terms for repayment such as length and payment amount of capital can also be included in the characteristic information. The partner characteristics can be defined by the parameters p, which is defined as the ratio of money invested by a partner divided by the amount of money needed to start the business. Alternatively, the parameter p can be defined by the sum of money invested by the partner plus the amount of potential business to be given per year divided by the total amount of money invested plus the first year revenue.

Potential logistic partners can also be included in the partner database. Logistic partners can include suppliers or vendors that are capable of providing shipping, packaging and other logistical goods and/or services. Characteristics that can be associated with logistical partners can include availability, costs, skill level, locations, services provided, goods provided, e-connectivity and the ability to use e-commerce and electronic communication. In addition of the above mentioned features of the potential logistic partners, the key characteristic will be that the logistic partner is going to provide the same services at the same or lower cost as they will be providing to key competitors of the business that are in other locations.

Potential administrative partners can include legal partners, accounting partners and other partners that can act as suppliers or vendors of management goods and services. Characteristics associated with administrative partners can include availability, costs, locations, services provided, skill level, e-connectivity, and the ability to use e-commerce and the ability to use electronic communications. Administrative partners can also include governmental partners. Governmental partners may include local, regional, national and even foreign partners. The key characteristics that will be used in the selection of administrative partners will be the ability to supply: (a) hard cash on hand, (b) land, electricity, water resources to be provided free, low-cost, or where the value of the services provided compared to the utility realized make partnering with the administrative partner desirous.

Potential technical partners include both partners supplying, licensing or selling existing technology such as equipment manufactures as well as research and development partners for creating and supplying, licensing or selling the business new technologies. The characteristics associated with technical partners can include the technology offered, services offered, availability of technology offered, and cost of technology. Availability can include whether the technology is immediately available to be supplied to the business, available to be supplied in the future, or restricted in some manner by such restrictions as lead time or licensing. The potential technical partner should be capable of supplying the current state of the art technology plus the next generation of technologies for the future. In addition, the potential partner must be willing to transfer the engineering, design and manufacturing technology to the business to allow the business to the technology that the potential technical partner is currently operating.

Potential customer partner characteristics can include manufacturing capacity for at least five years plus amount of money the partner is willing to invest towards the capital cost required to establish the business if any.

As well as the characteristic information as desired above for the partners, a weight can be included in the partner characteristic information. Weight represents the preference that such partner is preferred by the business.

Examples of weights used in the selection of various partners are shown in Table I. Table I has three columns showing the category of potential partners, the partners in each category, and the weight used for each potential partner. For example, A can indicate potential financial partners, B can include potential logistic partners, C can include potentials customers and Z can include other partners. Within each category, a listing of potential partners for that category is provided. The weight of these partners allows the partners to be ranked from highest to lowest. The highest rated partner has an initial weight of X. Factors that can influence the weight can be the reputation of the partner quantified by leading edge technology provider, reliability quantified by the number of years the partner has been in the business of supplying that partner's goods or services and the profitability status during those years, the intellectual property protection of the partner quantified by the number of cases lost in litigation, market capitalization quantified by the recent data regarding the percentage of market share, conflicts quantified by the total number of lawsuits the company has been involved within the last two years, potential conflict quantified by any export control violation or SEC violation, and other problems.

TABLE I
Weights used in Optimization

| Class of Business | | |
|---|---|---|
| Partners | Partners in a Class | Weight Used |
| A | A1 | Wa1 |
| | - - - | - - - |
| | An | Wan |
| B | B1 | Wbn |
| | - - - | - - - |
| | Bn | Wbn |
| C | C1 | Wc1 |
| | - - - | - - - |
| | Cn | Wcn |
| - - - | - - - | - - - |
| Z | Z1 | Wz1 |
| | - - - | - - - |
| | Zn | Wzn |

The location database can contain a variety of characteristics associated with potential locations for establishing a business. Location characteristics may include, workforce information. Workforce force information may include the number of employees available in a location, the number of unemployed employees in a location, or the turnover rate for employees in that location. Workforce information may be directed to the type of employee or the employee's particular skill that the business can determine if the potential employees have the necessary skills to work at the business. For example, the number of available engineers may be more important to a business needing engineers than gross labor force numbers. Information regarding of industries already existing in the location is relevant to this determination. The location database can also include characteristics associated with workforce costs, such as the average salary or hourly rate that is paid to the potential employees in the location as well as recent unemployment data. The location database can also include characteristics associated with higher education such as the number of higher educational institutions in a particular location, the number of vocational training schools. This information will help to determine whether the potential employees will have sufficient education and/or whether new employees will be able to be adequately trained. The location database can also include characteristics associated with culture quality of life such as natural and manmade recreation available at the location to ensure that the employees of the business will have a good quality of life so that the business can recruit new employees. The location database can also include characteristics associated with economic development incentives, location regulations, location tax information, information infrastructure, transportation infrastructure information. This information will help determine the logistics and costs of locating the business in the potential locations.

Location characteristics can also include the intellectual property protection rating of the location. One factor in selecting a location where to operate a business is the scope of intellectual property protection afforded by that location. Certain locations are more protective of their businesses' intellectual property. These are the type of countries businesses are best suited to do business in. For example, it has been reported that U.S. companies lost over $1.8 billion in IP theft in 2002 in China alone. Therefore, if a business is engaged in research and development in China, the risks of piracy and other damages related to IP misappropriation can be higher. Further, a lack of intellectual property protection can lead to depressed profits. Note that strike suits are also not desired, meaning that large numbers of suits without any basis filed against a company for the purpose of extracting financial gain. Therefore, an intellectual property protection (IPP) index is associated with each location and used to measure the risk associated with that location's intellectual property protection. The IPP is calculated by dividing the number of patent infringement cases filed into the number of patent infringement cases resulting in victory for the plaintiff. This number will reflect a score for a location indicating their willingness to protect intellectual property. The smaller the IPP index, the better the score. Note that an IPP index can exist for potential partners as well as for potential locations. For partners, the index is calculated by dividing the number of lawsuits won against the partner by the number of lawsuits filed. Again, the smaller this number, the better the score. When determining if the results of the litigation is a victory, a variety of different methods can be used. Victory does not need to be limited to a judge or jury verdict in favor of the plaintiff resulting in a cash award of damages. Rather, victory for the plaintiff may include a publicly known settlement that is favorable for the plaintiff, an injunction that does not yield any monetary results for the plaintiff, the publicly known agreement of a defendant to cease and desist in their actions, or other such beneficial results.

Location characteristics can include governmental monetary information. This information may include tax rates for industry, tax rates for individuals, or incentives available for businesses. By including this information, a location with a high tax rate may not be undesirable if incentives offered for a business overcome any disadvantages associated with a high tax rate. The location data base can be characterized by additional data that include the water, sewer and utility rates, the corporate and personal tax rates as well as any financial incentives that may be available for a particular type of industry for all the time or over a limited period. Additionally, the data base may include the land, water and air transportation facilities and infrastructure available at a given location. Based on this information, a location with higher tax rate may turn out to be beneficial for an industry that consumes large amount of water and electricity and capitalize the low utility rates available at the location. Location information may also include infrastructure information. Infrastructure information may include information concerning airports at a location, roads, and specifically major transportation thoroughfares linking business sites to airports and other important facilities, schools, housing, quality of life, electricity, and sewer arrangements. Airports and roads are important to manufacturing businesses since distribution channels use these resources. Although a location may lack a desired airport, locations are often eager to attract new business and are willing to construct resources such as airports or roads to attract such a new business.

Therefore, location information can include information representing a location's willingness to provide such resources for the business. Resources can include the qualifications and number of engineers, number of trained technicians, number of operators, utility rates, corporate and personal tax rates, financial incentives, number of higher educational institutions, number of vocational training schools, land, air and water transportation, storage facilities available, natural and man made recreational facilities, and natural disaster history such as earthquakes, hurricanes and tornados. Schools may also be important to a manufacturing business, both in the quality of workers being produced by those schools, and the quality of schools available for the children of employees of the business to attend. Quality of life, like schools, is important to businesses for attracting employees. Electricity, water, sewer and other utilities may also be important to business, specifically, manufacturing business. As such, location information can include the existence of, and feasibility of these resources to aid a business in analyzing a location.

The quality of life information can be included in location characteristics. This information may include real estate and property costs, nearby shopping facilities to the business, natural resources such as lakes, mountains, oceans, and other recreational facilities.

Location information can also include the existence of raw materials in a location or the distance from a location. The location characteristics can also include the costs and availability of raw materials. By including raw material information in location characteristics, a business can be aided by a determination as whether it is more advantageous to purchase and import raw materials from another location rather than mine raw materials from the location where the business intends to locate.

The type of administrative bodies and government present may also be included within the location information. For example, the existence of administrative entities, and governmental entities designed to assist business would be preferable to many industries. Location characteristics may also include a weight representing a preference for each type of resource present or desired at the location.

Server 14 can provide these determinations by using traditional linearly constrained global optimization algorithms such as described in the paper Linearly Constrained Global Optimization: A General Solution Algorithms with Applications by Hossein Arsham, et al as published in Applied Mathematics and Computation herein incorporated by reference and the book, Multiple Criteria Decision Making: Eight Concepts of Optimality by Milan Zeleny herein incorporated by reference. In another embodiment, the general non-linear constrained optimization approach can be used such as disclosed in the publication accessible at http://wwwfp.mcs.anl.qov/otc/Guide/OptWeb/continuous/constrained/nonlinearcon/ hereinafter incorporated by reference). Techniques that may be used to solve constrained optimization as present in this invention are reduced-gradient methods, sequential linear and quadratic programming methods, and methods based on augmented Lagrangians and exact penalty functions. These approaches can further use dynamic models. These methods can be dynamic, rather than static, by using sensitivity analysis as described at http://www.maaw.info/ConstrainoptTechs.htm and hereinafter incorporated by reference. This sensitivity analysis involves determining the sensitivity is the solution to changes in the constraints associated with the model. In one embodiment, the non-linear constrained optimization can give satisfactory results. In one embodiment, the dynamic models of non-linear constrained optimization can be used.

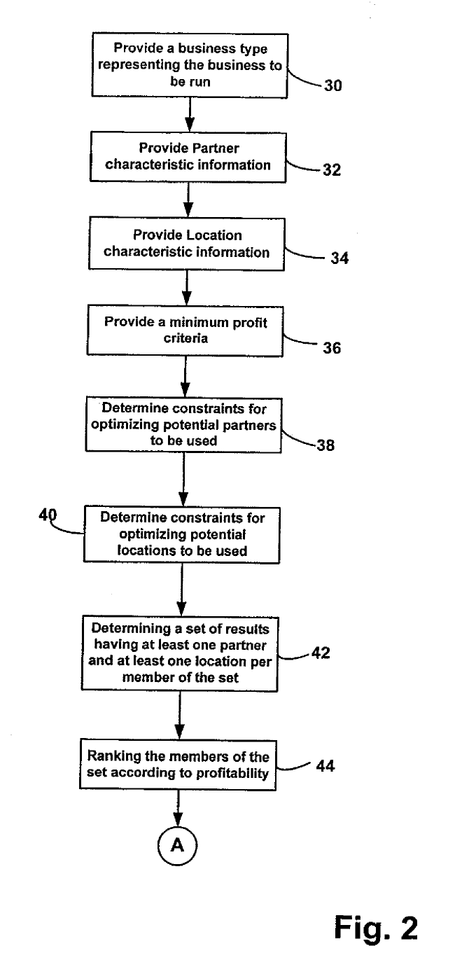

Referring now to FIG. 2, the system may begin at any number of steps. The user may begin the process by entering any number of combinations of known values. The user may wish to determine what business they wish to operate based on the location and a minimum profit desired. Alternatively, the user may want to determine the location of operation based on a predetermined type of business. The user may also wish to determine the best location based on the minimum profit desired. Further, the user may wish to determine the type and location of the business according to a minimum profit desired. For example, at step 30, the user may provide a business type as well as the potential partner characteristics and location characteristics that will be needed to operate the business. Afterwards, partner and location characteristic information representing objective representations of characteristics of potential partners and locations available to the business is provided at steps 32 and 34 respectively. Then, at step 36 the user may provide a minimum profit criterion. This minimum profit criterion represents the lowest profit margin at which the user desires to operate the business. At steps 38 and 40, constraints for optimizing potential partners and locations are determined. The system then determines what locations and partners are available. The calculation used and modeling employed can be those described listed above. The system determines a set of results having at least one partner and at least one location per each member in the set. The system may then rank the members of the set according to profitability at step 44. For example, the set of partners being the most profitable would be ranked first, and the set of partners being the least profitable would be ranked last. The ranking of the partners and locations will be done by retrieving information from the partner and location databases and using the methods described above to determine the least and most profitable.

Further, the partner database can contain information representing whether a partner such as a supplier of intellectual property may be willing to engage in profit sharing rather than requiring cash payments for license fees. The user is provided with the set of available partners according to partner characteristics and based upon the determined effect of and selecting the partner or profit, select the most profitable partners at step 42.

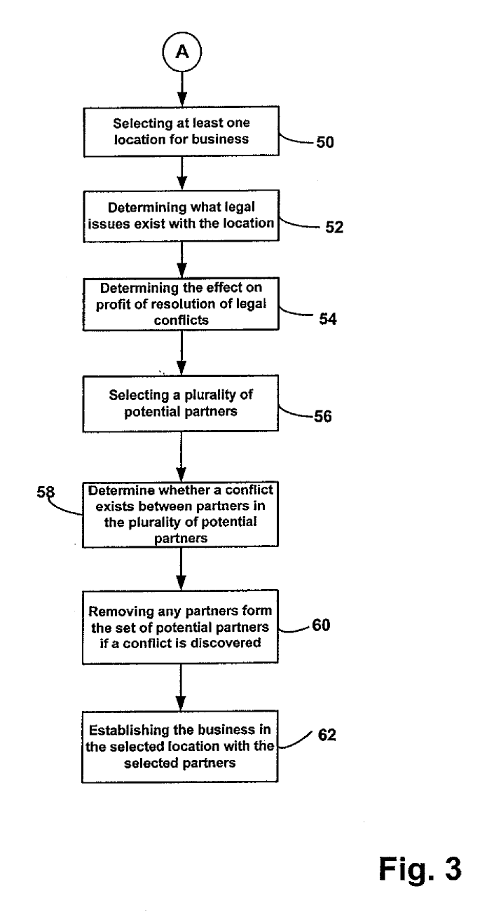

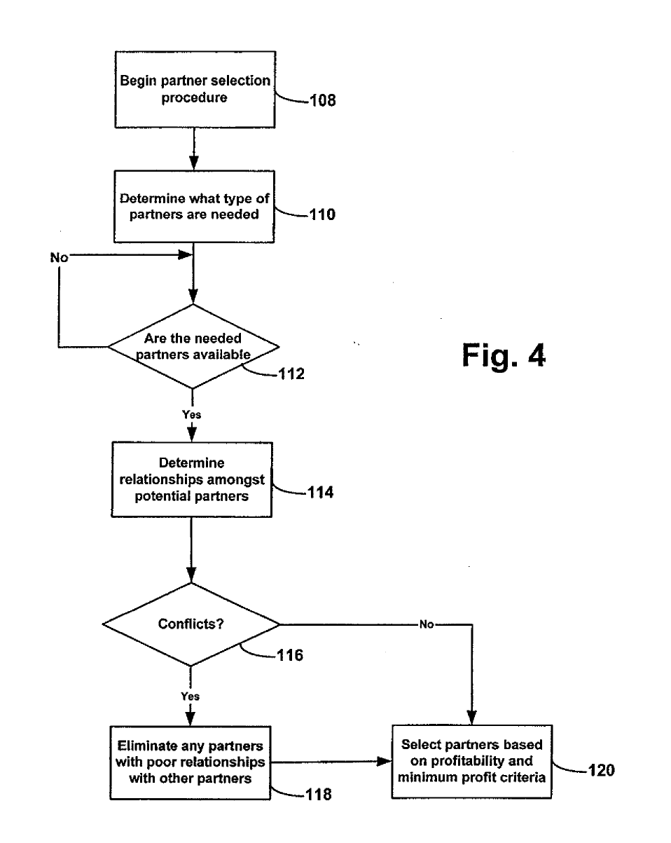

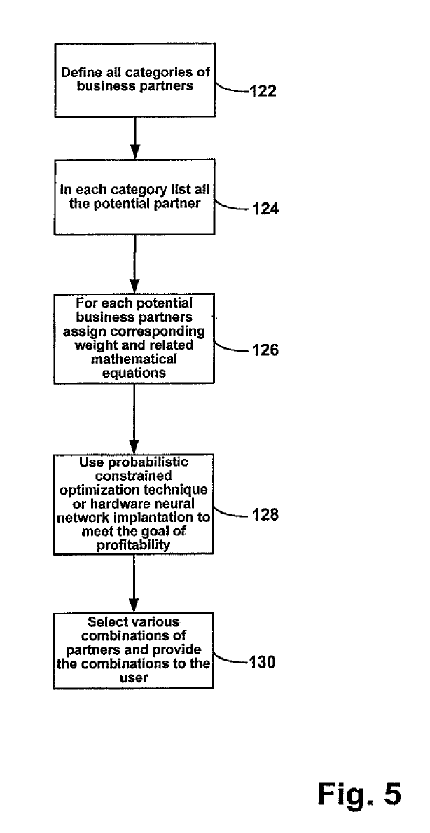

Referring now to FIG. 3, at step 50, the user selects at least one location. Any legal issues existing with that location are determined at step 52. At step 54, the effect on profit of resolution of these conflicts is determined. At step 56, the user selects a plurality of potential partners. At step 58, the existence of any conflict between potential partners exists. Any partner having conflicts may be removed at step 60. The partner selection procedure is described more fully in FIGS. 4 and 5. The business is then established in the selected location with the selected partners at step 62.

Upon establishing the business at step 62, the user may need to determine whether legal or financial issues need to be made. For example legal issues can include partners having current business agreement with the main competitors or involved in litigation with other potential partners. These legal issues can be resolved by mutual negotiations and by modifying the prior business agreements. Products can be produced at step 52.

If a logistic issue needs to be resolved, such as the business partner having an agreement with the competitor, then the user uses the system to resolve the conflict.

As an example, if two partners A and B have a legal conflict such as being in litigation against each other or refusal to cross-license IP, then the weight associated with these partners will be lower, and the system may select only one of these two partners and select new partners for replacement of the conflicted out partner. At step 50, such determinations can be made using linearly constrained global optimization methods or a hardware neural networks. In the event of a neural network, the system makes these calculations by providing various output with different weights given under different sets of partners.

The business operated may be involved in the manufacture of components such as semi-conductors, etc. or in the business of producing systems using these components such as MP3 players. If the business is manufacturing components, the business may, from time to time, need to know if it would be more profitable to continue to manufacture components or if the business should switch to manufacturing systems based on available partners and minimum profit criterion entered by the business. Thus, during the operation of the business, the system can continue to monitor potential partners to determine if the business should switch products so as to be more beneficial in achieving the minimum profit criterion.

The decisions listed above can include decisions associated with monitoring the “concept to design” process. In the absence of appropriate business partners, the information needed for research and development may not be readily available. When a product is first conceptualized, the design process goes through several iterations before finally establishing a finished product that will achieve the goals of the design. While monitoring this process, the system will evaluate the process to determine if the end product being developed will be more or less profitable than originally designed. This is achieved by using the manufacturing machines of the potential partner that meet the tight design specifics. If the product being designed falls beneath the minimum profit criterion, then the process can be halted and a redesign can take place to ensure a product will meet the minimum profit criterion. Whatever changes need to be made can be made by management associated with this process. In current 90 nm manufacturing process of silicon chip manufacturing, a number of processing steps are carried out by batch processing method. The companies that manufacturer this type of machines are not going to be suitable partners for next generations of chips that will have feature size of 65 nm or even lower dimension. In future single wafer processing machines will provide the tight design specifics that are required to run a profitable business. The system will inform the user that partners who are manufacturer of batch processing machines are not suitable partners and that the process is not producing products that will meet the minimum profit criterion, and the invention can implement those changes such as making partnership with companies that manufacture single wafer processing equipment.

Referring now to FIGS. 4 and 5, the process of selecting partners indicated as step 56 on FIG. 3 is described in more detail. At step 108, the partner selection process begins. The business must determine what type of partners are needed at step 110. By way of example, a semiconductor manufacturing business is used for illustrative purposes only. For a semiconductor manufacturing business several types of partners are necessary. These partners can include, but are not limited to tool vendors, packaging companies, major IDM, customers, insurance, legal, EDA tool vendors, and investors. Note that state, local, and national governments may also be potential partners. At step 112 the business must determine if the needed partners are available by accessing the partner information. If those needed partners are not available, the business must continue to wait for those partners to become available. If those partners are available, then at step 114 the business must determine the relationship amongst those potential partners. At step 116, the business must determine if there are any conflicts amongst the potential partners. This is important in that a business cannot be successful if its partners are in conflict with one another. This will cause friction and delays in time to market which are the main advantages of this business model. Thus, any partners with conflicts or poor relationships with other potential partners are eliminated at step 118. The remaining pool of partners only contains partners that will potentially work with each other and the business to ensure profitability. At step 120 the minimum profit criteria is used to select from amongst these profits to ensure maximum profitability with the potential partners.

Referring now to FIG. 5, the determining of relationships between partners and the elimination of partners with less desirable relationships is described in more detail. At step 122, the system defines all categories of business partners before listing all the potential partners in a specified category at step 124. For each potential business partner, a corresponding weight and related mathematical equation is assigned to them. For example there are two potential partners Y1 and Y2. The first customer can provide 60% of the business, but is not willing to contribute any capital. Y2 can only provide 40% of the business, but is willing to contribute 20% of the start-up capital needed by the business. If the business has all the capital it needs, the system will assign a greater value to the percentage of business provided. However, if the business needs capital the system will place a greater weight on need for capital. In the first scenario Y1 will be selected, but in the second scenario Y2 will be selected. The system then at step 128 either uses probabilistic constrained optimization techniques or a hardware neural network to determine which potential partners are the most profitable and would meet the minimum profit criteria established in FIG. 2 at step 24. At that point, the user will select various combinations of partners at step 130.

While the above description is used to convey the invention to those skilled in the art, it is not to limit the scope of the following claims.

What is claimed is:

1. A system for determining the optimal location for establishing a business comprising:
a computer readable medium in communications with a processor;
a set of potential location information representing location characteristics including workforce information, workforce costs, location economic development incentives, location regulations, location tax information, information infrastructure, transportation infrastructure, location culture information, location quality of life and higher education information;
a set of potential partner information representing potential partner characteristics including suppliers of financial capital, physical capital, materials, labor, services, raw materials, experience, industry knowledge and references and;
a set of computer readable instructions that when executed by said process perform the steps of retrieving said set of potential location information, retrieving said set of potential partner information, receiving a set of manufacturing location criteria representing the needs of the manufacturing business for locating in a specific location, determining which, if any, locations represented by said potential location information meet said manufacturing business location criteria, displaying said results to the user, if there is a location that meets the manufacturing business location criteria, determining whether potential partners exists according to said manufacturing business criteria and said set of potential partner information so that the manufacturing business criteria are satisfied, if there is a potential location that meets the manufacturing business location criteria and there is a potential partner that meets the manufacturing business criteria, determining profits according to said set of potential location information and potential partner information, ranking each of said potential locations and potential partners according the profits associated with said potential location and potential partner and displaying the results to the user.

2. The system of claim 1 wherein said set of computer readable instructions further include instructions for receiving constraints for determining said potential partners and potential locations and said determination of said profits includes determining said profits according to said constraints.

4. The system of claim 2 wherein said set of computer readable instructions for receiving constraints further include instructions for determining linear constraints for global optimization.

5. The system of claim 2 wherein said instructions for receiving constraints for determining potential suppliers and potential locations include instructions for determining legal and regulatory issues to be resolved prior to locating said business at said potential location.

6. The system of claim 5 wherein said set of computer readable instructions include instructions for determining the effect on profit according to costs associated with resolution of the legal issues that are to be resolved prior to locating said business at said potential location.

7. The system of claim 1 wherein said set of potential partner information includes information representing conflicts between potential partners and said computer readable instructions include instructions for selecting a plurality of potential partners from said potential partner information and determining whether a conflict exists between said plurality of potential partners.

8. The system of claim 7 wherein said computer readable instructions include instructions for removing at least one potential partner from said selected plurality of potential partner if a conflict is discovered according to said discovered conflict.

9. A system for determining the optimal location for establishing a business comprising:
a computer readable medium in communication with a processor;
a set of potential location information representing location characteristics of a potential location where said business could locate including workforce information, workforce costs, location economic development incentives, location regulations, location tax information, information infrastructure, transportation infrastructure, location culture information, location quality of life and higher education information;
a set of potential partner information representing potential suppliers of goods and services to said business including suppliers of financial capital, physical capital, materials, labor, services, raw materials, experience, industry knowledge and references and;
a set of computer readable instructions that when executed by said process perform the steps of retrieving said set of potential location information, retrieving said set of potential partner information, receiving a set of manufacturing location criteria representing the needs of the manufacturing business for locating in a specific location, determining which, if any, potential locations represented by said potential location information meet said manufacturing business location criteria, displaying said results to the user, if there is a location that meets the manufacturing business location criteria, determining whether potential partners exist in proximity to said potential locations according to said manufacturing business criteria and said set of potential partner information so that the manufacturing business criteria are satisfied, if there is a potential location that meets the manufacturing business location criteria and there are sufficient potential suppliers that meet the manufacturing business criteria, determining profits according to said set of potential location information and potential supplier information, ranking each of said potential locations and potential partners according the profits associated with said potential location and potential partner and displaying the results to the user.

10. The system of claim 9 wherein said computer readable instructions include instructions for determining which potential partners are not in proximity to said potential location and displaying said potential partners not in proximity to said potential location to the user.

11. The system of claim 9 wherein said manufacturing business location criteria includes criteria for a nanosystems manufacturing.

12. The system of claim 9 wherein said manufacturing business location criteria including criteria for a microsystems manufacturing.

13. The system of claim 9 wherein said set of computer readable instructions includes instructions for selecting a potential location from said set of potential location information and determining existing legal and regulatory hurdles to locating said business at said potential location.

14. The system of claim 13 wherein said set of computer readable instructions include instructions for determining the effect on profit according to costs associated with resolution of legal issues prior to locating said business at said potential location.

15. The system of claim 9 wherein said set of potential partner information includes information representing conflicts between potential partners and said computer readable instructions include instructions for selecting a plurality of potential partners from said set of potential partner information and determining whether a conflict exists between said plurality of potential partners.

16. The system of claim 15 wherein said computer readable instructions include instructions for removing at least one potential partner from said selected plurality of potential partners if a conflict is discovered according to said discovered conflict.

17. A system for determining a location for establishing a business comprising:
a computer readable medium in communications with a processor;
a set of potential location information representing location characteristics of a potential location where said business could locate;
a set of potential partner information representing potential suppliers of goods and services to said business;
a set of computer readable instructions that when executed by said process perform the steps of retrieving said set of potential location information, retrieving said set of potential partner information, receiving a set of manufacturing location criteria representing the needs of the manufacturing business for locating in a specific location, determining potential locations meeting said manufacturing business location criteria, determining potential partners according to said manufacturing business criteria and said set of potential partner information, determining profits according to said set of potential location information and potential partner information and displaying the results to the user.
